(19) United States
(12) Patent Application Publication
(10) Pub. No.: US 2004/0096810 A1
(43) Pub. Date: May 20, 2004

(54) Interactive playset

(76) Inventors: Harold Walter Wells, Huntington, NY (US); Mary Ann Cogliano, Santa Rosa, CA (US)

Correspondence Address: Hoffman, Wasson & Gitler, P.C., Suite 522, 2361 Jefferson Davis Highway, Arlington, VA, 22202, US

(21) Appl. No.: 10/299,773

(22) Filed: Nov. 20, 2002

(51) Int. Cl. G09B 23/28

(52) U.S. Cl. 434/268

(57) ABSTRACT

A playset in which the position of various vehicles or characters will be depicted upon a video screen or monitor. A method of identifying a location is provided in a playset map upon which the vehicles or characters would traverse. Based upon the position of the vehicles or characters, different scenes would be depicted on the video screen or monitor.

### FIELD OF THE INVENTION

The present invention is directed to an interactive playset in which the position of a toy vehicle or analogous device traveling along a route upon a base playmat is depicted upon a video screen.

### BACKGROUND OF THE INVENTION

The utilization of electronics in our everyday lives has been quite pervasive in the 50 years since the development of the transistor. Electronic devices or chips have been utilized to operate and control everyday commercial appliances such as refrigerators, microwaves, washing machines and dishwashers. However, perhaps the most profound utilization of electronics has been in the miniaturization of these electronic devices to produce personal computers coupled to a monitor to provide a display. This miniaturization and utilization of computers have now been extended to the toy industry in the form of initially rudimentary and now increasingly complex video games. These games were initially played with a console connected to a television set. However, in the last ten years, the industry has expanded into video games played on personal computers as well as devices such as the game boy. While initially, these video games were used as a game played by a single player or a group of players, the industry has extended itself to a field of teaching devices. These devices would be utilized by pre-school children, school age children, teenagers as well as adults.

A number of patents have issued in which a computer would be utilized in conjunction with an amusement device for tracking the position of a playing piece or similar device on a planer surface. For example, U.S. Pat. No. 6,102,397 issued to Lee et al describes a computer interface apparatus for an amusement device. An interface assembly is coupled to a central processing unit contained in a remote computer provided with a display screen. The purpose of the interface assembly is to act as an interface between the players of the game and the central processing unit for the purpose of exchanging information therebetween. As shown in FIG. 1, different board game inlays are provided and sized to fit across the planer surface of the interface assembly. The status of various game pieces used in a game would be read by the central processing unit, by the physical movement of the game pieces over the gameboard inlay.

U.S. Pat. No. 4,662,635 issued to Enokian displays a video game in which a television screen or cathode ray tube is used to display a variety of plays previously performed by living human beings. The video game would include a television, a play back unit, as well as a game control console.

U.S. Pat. No. 4,986,187 issued to Booth et al relates to a toy vehicle assembly having a video display. A toy vehicle, such as a train moving about a track, would include an optical sensing means connected to a monitor for displaying what the optical sensing means senses.

Although the patent to Lee et al does contain an interface device provided as an intermediary between a board game and a computer having a display screen, in which the intermediary device would allow the computer to sense the position of a playing piece on the board during a play, this patent does not anticipate or suggest the use of a sensing means for allowing a player or players to view a scene based upon the exact location of a playing piece on the board.

### SUMMARY OF THE INVENTION

The deficiencies of the prior art are addressed by the present invention which is directed to an interactive playset allowing a child or children to manipulate various toys, such as cars as the cars travel through a mythical town. A playmat would be included onto which various features of a town would be depicted. The town would be provided with different roads having tracings thereon, allowing a computer to determine the position of each toy, such as a car on the playmat. One or more interactive memory devices are provided on compact disks and would be utilized for the child to view the travel of his or her toy through the town as shown on a display. The display could be segmented allowing the child to view other children's locations as well as the interior, exterior or other views of the child's own toy. A keyboard would be utilized to change the sights and sounds viewed by the child. As can be appreciated, the numbers and types of scenes utilized can be virtually limitless, such as a military scene, a dollhouse, a safari or the like. Furthermore, the child would also be able to travel to various geographic or historical locations.

### BRIEF DESCRIPTION OF THE DRAWINGS

While the novel features of the invention are set forth with particularity in the appended claims, the invention, both as to organization and content, will be better understood and appreciated from the following detailed description taken in conjunction with the drawings, in which:

FIG. 1 is a perspective view of the present invention as depicted in a town setting;

FIG. 2 is a view of a monitor showing the output of four people using the playset;

FIG. 3 is a view of the monitor depicting a weather condition;

FIG. 4 is another view of the monitor showing its use during the night;

FIG. 5 is a view a vehicle which can be used in the present invention; and

FIG. 6 is a block diagram showing the operation of the present invention.

### DETAILED DESCRIPTION OF THE INVENTION

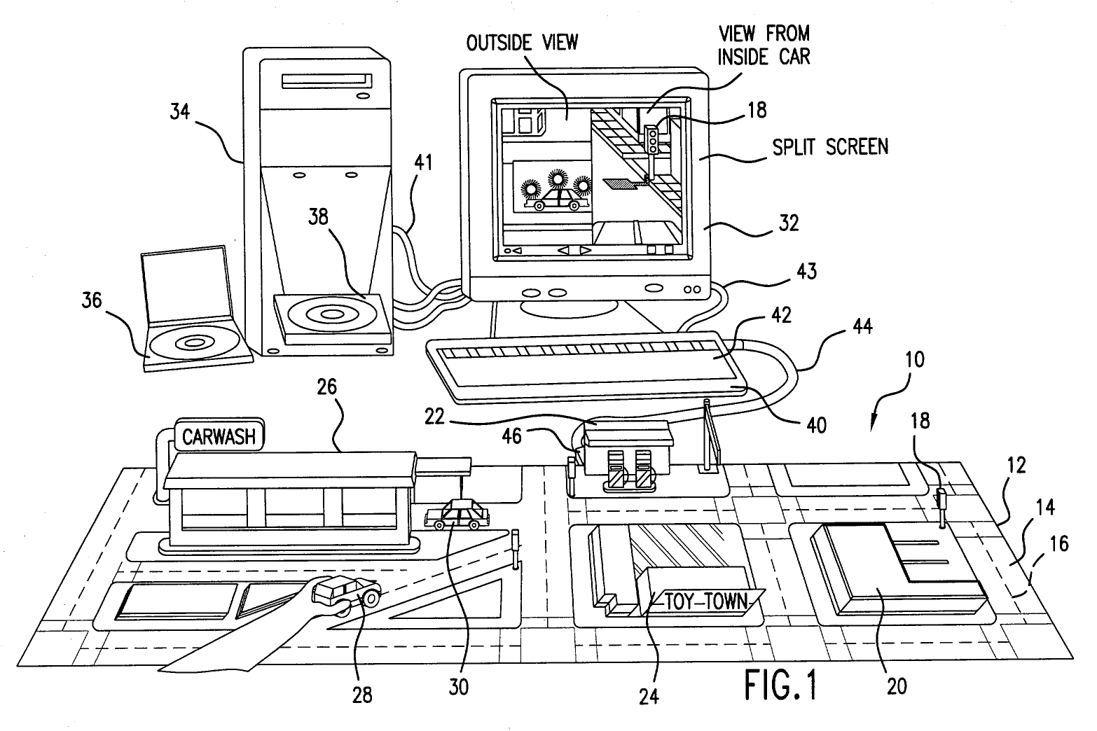

The present invention 10 as illustrated with respect to FIG. 1, shows one of a multitude of scenes which can be practiced according to the present invention. The scene depicted in FIG. 1 is of a small town. This town is provide upon a vinyl mat 12 or vacuum formed base. The town has a plurality of streets or roads 14 each provided with a conductive tracing 16 onto which cars 28, 30 are shown. As can be appreciated, different types of vehicles can be utilized without departing from the scope of the present invention. The town has a plurality of buildings 20, 22, 24 as well as a car wash 26 affixed to the top of the mat 12. Various traffic control devices, such as a traffic light 18 are also provided.

The present invention operates under the control a central processing unit (CPU) 34 including a hard drive into which replaceable memory devices, such as compact disks 36, 38 are placed. The CPU 34 is in communication with a standard monitor 32 via a communication cable 41. The compact disks 36, 38 contain information allowing the monitor to display various scenes based upon the position of one of the cars on the mat 12. A cable 43 connects the monitor 32 to a standard keyboard 40 provided with an overlay 42. The keyboard 50 is connected to the mat 12 via a communication cable 44 plugging into the mat 12 using a connector device 46. The position of each of the cars 28, 30 is transmitted to the CPU 34 utilizing the conductive tracings 16. The present invention, as shown in the drawings, would utilize up to four vehicles. However, as it can be appreciated, more than four vehicles can be utilized. Based upon the position of each of the vehicles, different information is displayed on the monitor 32. For example, if only one car is being utilized, the monitor 32 would project information relating to that one vehicle.

Either automatically based upon a program associated with the invention, or by depressing the keys on the keyboard 40 with or without the overlay 42, one or more scenes would be depicted upon the monitor 32. For example, as shown in FIG. 1, one side of the screen shows an outside view of the car, and the second side of the screen shows the view as shown from inside the car. As can be appreciated, in the embodiment shown in FIG. 1, the child can learn rudimentary rules of the road. For example, as one of the cars approaches the traffic light 18, it could change from a green light to a red light. The child would then wait until the traffic light changes from red to green before proceeding through the intersection. Furthermore, in the embodiment shown in FIG. 1, when the vehicle 30 proceeds through the car wash 26, the scene would change showing what the child would see when the car proceeding through the carwash.

Each of the vehicles would be constructed to scale with respect to the buildings provided on the mat 12. For example, a 1/64 scale could be utilized. As shown with respect to FIG. 5, a vehicle 50 could be provided with operational windshield wipers 52 as well as headlights 54. These devices could be operated utilizing the keyboard itself 40 or with the overlay 42.

Each of the vehicles could be provided with a battery or similar power source to operate the windshield wipers 52 as well as the headlights 54. Additionally, this battery source could be utilized to operate a low power transmitting device transmitting unique signals through the conductive tracing 14 to the CPU 34. In this manner, the CPU 34 would know the position of each of the vehicles on the mat 12. Furthermore, the computer could be provided with a speaker allowing various sounds to be produced.

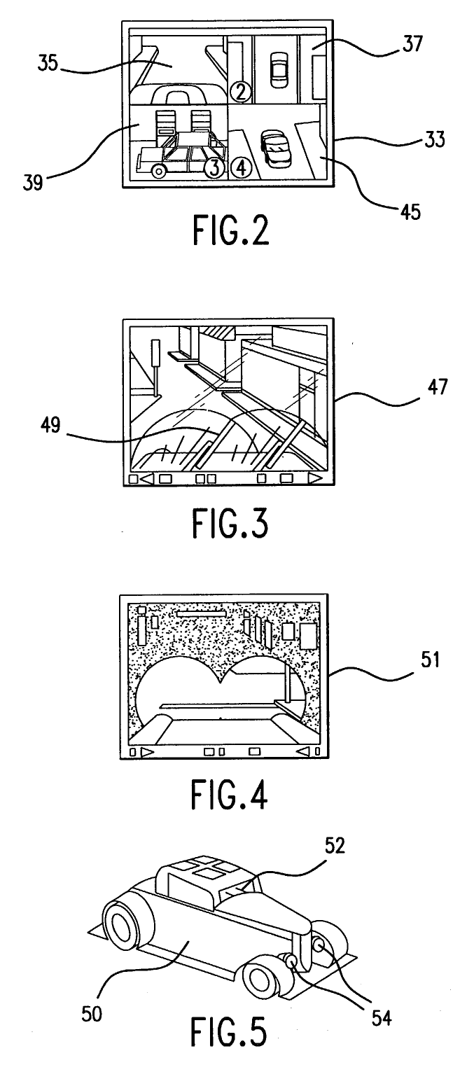

FIG. 2 shows a monitor 33 having four scenes that can be depicted for each of the cars. For example, one scene 35 is from the inside of the car, a second scene 37 is an aerial view of the car, scene 39 is an outside view of the car and scene 45 is a rear view of the car. As can be appreciated, if more than one vehicle would be utilized at any one time, scenes from each of the vehicles can be depicted in one of the quadrants of the monitor 32.

FIG. 3 illustrates a monitor 47 in which an operator would change the weather conditions. These conditions can change from sunny to rainy as well as to snow automatically based upon a program provided on the computer disks or by depressing one of the keys on the keyboard . The child can initiate the operation of the windshield wipers 49 by depressing the appropriate key on the keyboard 40 with or without the overlay 42. When this occurs, the windshield wipers 49 will begin to operate on the monitor screen 47.

FIG. 4 illustrates the situation in which a child would change the scene from day to night and then back again. Alternatively, the scenes are automatically changed, based upon a program included on the compact disk. At this point, the child would operate the headlights of the vehicle 54 and the scene on the monitor 51 would illustrate the utilization of the headlights. In both the scenes depicted in FIG. 3 and FIG. 4, when the child correctly operates the windshield wipers shown in FIG. 3 as well as the headlights shown in FIG. 4, the headlights 54 as well as the windshield wipers 52 can then be operated on the vehicle 50.

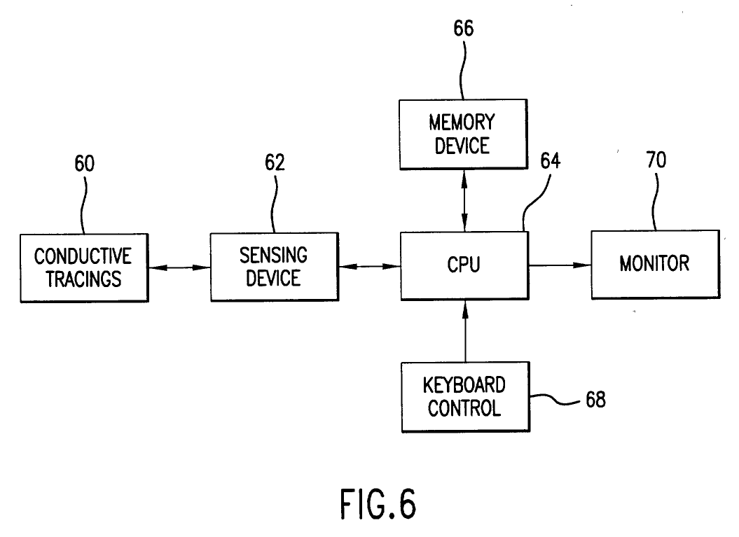

FIG. 6 shows a block diagram of the key elements of the present invention. Based upon the sensed position of each of the vehicle based upon the utilization of the conductive tracings 60, a sensing device 62 associated with the CPU 64 would sense the position of each of the vehicles on the mat 12. Therefore, in conjunction with a memory device 66 in communication with the CPU 64, a monitor 70 would then depict the appropriate scene. The type of scene which would be shown on the monitor 70 would operate in conjunction with a keyboard control 68 allowing the child to change the scenes illustrated as shown in FIG. 2 as well as a change in the weather and a change from day to night as shown in FIGS. 3 and 4. As can be appreciated, other types of scenes can be employed.

Furthermore, although the present invention was described in conjunction with a small town, other scenes could also be employed utilizing other types of vehicles or characters. For example, various historical scenes can be depicted as well as different localities.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed:

1. An interactive playset comprising:
at least one character or vehicle;
a planar mat provided with a means for identifying the location of said character or vehicle on said planar mat; and
a microprocessor provided with a memory device and a video monitor, said memory device containing a series of scenes, allowing said video monitor to display a scene based upon the location of said character or vehicle on said planar mat sensed by said means for identifying the location of said character or vehicle.

2. The interactive playset in accordance with claim 1, wherein said planar mat is provided with a series of roads or trails on which said character or vehicle travels.

3. The interactive playset in accordance with claim 2, wherein said planar mat is provided with at least one three dimensional structure.

4. The interactive playset in accordance with claim 2, wherein each of said characters or vehicles is provided with a transmitter, transmitting a unique signed signal sensed by said means for identifying the location of each of said characters or vehicles.

5. The interactive playset in accordance with claim 3, wherein each of said characters or vehicles is provided with a transmitter, transmitting a unique signed signal sensed by said means for identifying the location of each of said characters or vehicles.

6. The interactive playset in accordance with claim 1, wherein said memory device is removable.

7. The interactive playset in accordance with claim 4, wherein said video monitor simultaneously displays the location of each character or vehicle provided on said planar mat.

8. The interactive playset in accordance with claim 5, wherein said video monitor simultaneously displays the location of each character or vehicle provided on said planar mat.

9. The interactive playset in accordance with claim 5, wherein said characters or vehicles may enter one of said three dimensional structures.

10. The interactive playset in accordance with claim 9, wherein said video monitor displays a scene of one of said characters or vehicles within one of said three dimensional structures.

11. The interactive playset in accordance with claim 1, further including a keyboard provided with at least one key for altering said scene.

12. The interactive playset in accordance with claim 11, wherein said key alters the weather associated with said scene.

13. The interactive playset in accordance with claim 11, wherein said key alters the orientation of said scene.
